(19) United States
(12) Patent Application Publication
(10) Pub. No.: US 2025/0226455 A1
(43) Pub. Date: Jul. 10, 2025

(54) CYLINDRICAL BATTERY AND ASSEMBLY PROCESS THEREOF

(71) Applicant: LANJING NEW ENERGY (JIAXING) CO., LTD., Jiaxing (CN)

(72) Inventors: Shunan FENG, Jiaxing (CN); Ju WANG, Jiaxing (CN); Chuntai GUO, Jiaxing (CN); Wei HE, Jiaxing (CN); Yizhi YANG, Jiaxing (CN); Zhaohui LUO, Jiaxing (CN)

(73) Assignee: LANJING NEW ENERGY (JIAXING) CO., LTD., Jiaxing (CN)

(21) Appl. No.: 19/093,345

(22) Filed: Mar. 28, 2025

Related U.S. Application Data
(63) Continuation of application No. PCT/CN2023/082128, filed on Mar. 17, 2023.

(30) Foreign Application Priority Data
Sep. 29, 2022 (CN) 202211202448.2

(51) Int. Cl. H01M 10/0587; H01M 50/107; H01M 50/152; H01M 50/186; H01M 50/528; H01M 50/533; H01M 50/536; H01M 50/636

(52) U.S. Cl. CPC H01M 10/0587; H01M 50/107; H01M 50/152; H01M 50/186; H01M 50/528; H01M 50/533; H01M 50/536; H01M 50/636

(57) ABSTRACT

A cylindrical battery includes a case assembly, a polar pillar is provided under a case of the case assembly; a second current collector, a jelly roll, a first current collector, and a cover plate are provided sequentially in the case from bottom to top; tabs at two ends of the jelly roll are fixedly connected to the first current collector and the second current collector, respectively; the second current collector and the case are insulated by an insulating element; a protrusion is formed in a circumferential direction of the insulating element; a height of the protrusion is identical to a height of the polar pillar; the cover plate is fixedly provided on the first current collector; the cover plate and the case are sealed by a sealing ring; when a liquid injection hole is formed in the cover plate or in the polar pillar.

### CROSS-REFERENCE TO RELATED APPLICATIONS

This application is a continuation of International Patent Application No. PCT/CN2023/082128 with a filing date of Mar. 17, 2023, designating the United States, now pending, and further claims priority to Chinese Patent Application No. 202211202448.2 with a filing date of Sep. 29, 2022. The content of the aforementioned applications, including any intervening amendments thereto, is incorporated herein by reference.

### TECHNICAL FIELD

The present disclosure belongs to the technical field of lithium-ion batteries, and particularly relates to a cylindrical battery and an assembly process thereof.

### BACKGROUND

At present, the cover plate of the conventional cylindrical battery has a complex structure. When the cap as a positive electrode and the case as a negative electrode are assembled into a battery module, the positive electrode and the negative electrode are electrically connected from two ends of the cylindrical battery. This is not convenient to design and weld a busbar of the external module. Besides, the power performance of the battery cannot be ensured for few tabs. As the cylindrical size increases, the existing tab or structure cannot achieve rapid heat transfer. The cell with an increased diameter is likely to move in use to affect a welded point, leading to a dry joint to affect the performance and service life. The flange at an edge of the current collector is connected to the case by laser welding, and at the welded position, a roll groove is formed. In this way, the welded point between the current collector and the tab of the jelly roll is pulled easily, and the nickel-plated layer of the case is damaged to become rusty. For some other designs in which the current collector is connected to the case, the elastic edge of the current collector is lapped on an upper edge of the roll groove, and is connected by laser welding. This makes the welded surface uneven to cause poor sealing subsequently.

### SUMMARY OF PRESENT INVENTION

Aiming at the defect in the prior art, the present disclosure provides a cylindrical battery which has high electrical conductivity, high thermal conductivity, good fast-charging capability, and cost effectiveness.

To achieve the above objective, the present disclosure adopts the following technical solutions:

A cylindrical battery includes a case assembly, a polar pillar is provided under a case of the case assembly; a second current collector, a jelly roll, a first current collector, and a cover plate are provided sequentially in the case from bottom to top; tabs at two ends of the jelly roll are fixedly connected to the first current collector and the second current collector, respectively; the second current collector and the case are insulated by an insulating element; a protrusion is formed in a circumferential direction of the insulating element; a height of the protrusion is identical to a height of the polar pillar; the cover plate is fixedly provided on the first current collector; the cover plate and the case are sealed by a sealing ring; when a liquid injection hole is formed in the cover plate, a top of the cover plate is sealed by a rivet; and when the liquid injection hole is formed in the polar pillar, a bottom of the polar pillar is sealed by a cap.

Further, a cross-section of the polar pillar is a T-shaped structure; and the polar pillar includes a center portion provided with a central hole, and an inner wall provided with a plurality of steps having gradually increased inner diameters.

Further, a cross-section of the polar pillar is an I-shaped structure; and the polar pillar is directly riveted with the case in a sealing manner.

Further, the cover plate has an uneven structure; a cover plate boss is provided on the cover plate; the cover plate boss is configured to press an elastic structure of the first current collector after assembled; and an inner side of the cover plate boss is connected to a conductive handle of the first current collector.

Further, a blind hole is formed in the cover plate boss.

Further, the liquid injection hole is formed in the cover plate boss.

Compared with the prior art, the cylindrical battery in the present disclosure has the following advantages:

(1) With the structure of the current collector and the cover plate, the cylindrical battery provided by the present disclosure enhances the electrical conductivity and the thermal conductivity, thereby improving the fast-charging capability of the battery, improving the manufacturing efficiency, and lowering the cost.

(2) The conductive handle is provided on the current collector, and the conductive handle is connected to the cover plate, so the cylindrical battery provided by the present disclosure improves the electrical conductivity and the thermal conductivity.

Another objective of the present disclosure is to provide an assembly process of the cylindrical battery, to lower the cost and improve the manufacturing efficiency.

To achieve the above objective, the present disclosure adopts the following technical solutions:

An assembly process of the cylindrical battery includes the following steps:
S1, shaping the tabs of the wound jelly roll, such that the tabs on the jelly roll are closely attached in a planar state;
S2, laser-welding one of the tabs of the jelly roll with the second current collector to form a jelly roll assembly;
S3, inserting the jelly roll assembly into the case from an opening of the case;
S4, welding the second current collector with the polar pillar for fixing;
S5, at the opening of the case, and at a position above the jelly roll, squeezing the case toward an axis through a die, followed by rolling to form a roll groove;
S6, mounting the first current collector, and laser-welding the first current collector with another one of the tabs of the jelly roll;
S7, riveting the conductive handle of the first current collector with the cover plate having the sealing ring;
S8, pressing the cover plate on a flange of the first current collector at the opening of the case toward the axis for sealing;
S9, performing liquid injection through the liquid injection hole or drying a cell and then performing the liquid injection; and
S10, performing formation, degassing, liquid replenishment and sealing.

Further, when the liquid injection hole is formed in the polar pillar, the assembly process of the cylindrical battery includes the following steps:
X1, shaping the tabs of the wound jelly roll, such that the tabs on the jelly roll are closely attached in the planar state;
X2, laser-welding one of the tabs of the jelly roll with the second current collector to form the jelly roll assembly;
X3, inserting the jelly roll assembly into the case from the opening of the case;
X4, performing laser tailored welding on the second current collector and the polar pillar;
X5, at the opening of the case, and at the position above the jelly roll, squeezing the case toward the axis through the die, followed by rolling to form the roll groove;
X6, mounting the first current collector, and laser-welding the first current collector with another one of the tabs of the jelly roll;
X7, riveting the conductive handle of the first current collector with the cover plate having the sealing ring;
X8, pressing the cover plate on the flange of the first current collector at the opening of the case toward the axis for sealing;
X9, performing the liquid injection at the central hole of the polar pillar or drying the cell and then performing the liquid injection through the central hole of the polar pillar; and
X10, performing the formation, the degassing and the liquid replenishment or directly covering the cap, and laser-welding the polar pillar and the cap together for sealing.

Further, when the liquid injection hole is formed in the cover plate, the assembly process of the cylindrical battery includes the following specific steps:
Y1, shaping the tabs of the wound jelly roll, such that the tabs on the jelly roll are closely attached in the planar state;
Y2, laser-welding one of the tabs of the jelly roll with the second current collector to form the jelly roll assembly;
Y3, inserting the jelly roll assembly into the case from the opening of the case;
Y4, connecting the second current collector and the polar pillar by laser welding or ultrasonic welding;
Y5, at the opening of the case, and at the position above the jelly roll, squeezing the case toward the axis through the die, followed by rolling to form the roll groove;
Y6, mounting the first current collector, and laser-welding the first current collector with another one of the tabs of the jelly roll;
Y7, riveting the conductive handle of the first current collector with the cover plate having the sealing ring;
Y8, pressing the cover plate on the flange of first current collector at the opening of the case toward the axis for sealing;
Y9, performing the liquid injection at the liquid injection hole of the cover plate or drying the cell and then performing the liquid injection through the liquid injection hole of the cover plate; and
Y10, performing the formation, the degassing and the liquid replenishment or directly sealing the liquid injection hole by pull riveting.

Compared with the prior art, the assembly process of the cylindrical battery in the present disclosure has the following advantages:

(1) According to the assembly process of the cylindrical battery provided by the present disclosure, the cylindrical battery includes the bottom and the side sealed, and the top contacting the case. The case improves the electrical conductivity and the thermal conductivity. Meanwhile, in order that the case and the cover plate have stable electrical connection with a small resistance, the welding can be used to achieve the stable electrical conductivity.

(2) According to the assembly process of the cylindrical battery provided by the present disclosure, the liquid injection hole is formed in the cover plate. The liquid injection hole is sealed by the pull riveting. Since there is no structure sealed by welding, helium leak detection can be omitted in the manufacturing process, thereby lowering the cost and improving the manufacturing efficiency.

### BRIEF DESCRIPTION OF THE DRAWINGS

As a part of the present disclosure, the accompanying drawings are provided for further understanding of the present disclosure. The schematic embodiments of the present disclosure and description thereof are intended to explain the present disclosure and are not intended to constitute an improper limitation to the present disclosure. In the drawings:

FIG. 1 is a sectional view showing a case assembly according to an embodiment of the present disclosure;

FIG. 2 is an enlarged view of portion X shown in FIG. 2;

FIG. 3 is a schematic structural view showing a polar pillar according to an embodiment of the present disclosure;

FIG. 4 is a top view showing a first current collector according to an embodiment of the present disclosure;

FIG. 5 is a sectional view along line A-A shown in FIG. 4;

FIG. 6 is a top view showing a first current collector according to another embodiment of the present disclosure;

FIG. 7 is a sectional view along line B-B shown in FIG. 6;

FIG. 8 is a schematic view showing a second current collector according to an embodiment of the present disclosure;

FIG. 9 is a sectional view showing a second current collector according to an embodiment of the present disclosure;

FIG. 10 is a schematic view showing a cover plate according to according to an embodiment of the present disclosure;

FIG. 11 is a schematic view showing a cap according to according to an embodiment of the present disclosure;

FIG. 12 is an exploded view showing a cylindrical battery according to an embodiment of the present disclosure;

FIG. 13 is a partially sectioned side view showing a cylindrical battery according to an embodiment of the present disclosure;

FIG. 14 is an exploded view showing a cylindrical battery according to anther embodiment of the present disclosure; and

FIG. 15 is a schematic view showing an insulating element according to an embodiment of the present disclosure.

### REFERENCE NUMERALS

1—jelly roll, 2—case assembly, 21—case 21, 22—sealing element, 23—polar pillar, 231—first step, 232—second step, 233—third step, 234—central hole, 3—first current collector, 31—flange, 32—elastic structure, 33—first boss, 34—conductive handle, 4—second current collector, 41—second boss, 42—permeation hole, 5—cover plate, 51—cover plate boss, 52—explosion-proof snick, 53—liquid injection hole, 6—cap, 61—cap step, 7—insulating element, 71—protrusion, 8—sealing ring, 9—tab, and 10—rivet.

### DETAILED DESCRIPTION OF THE EMBODIMENTS

It should be noted that embodiments in the present disclosure or features in the embodiments may be combined with one another without conflict.

It should be understood that in the description of the present disclosure, terms such as “central”, “longitudinal”, “transverse” “upper”, “lower”, “front”, “rear”, “left”, “right” “vertical”, “horizontal”, “top”, “bottom”, “inside” and “outside” indicate the orientation or positional relationships based on the drawings. They are merely intended to facilitate and simplify the description of the present disclosure, rather than to indicate or imply that the mentioned device or components must have a specific orientation or must be constructed and operated in a specific orientation. Therefore, these terms should not be construed as a limitation to the present disclosure. Moreover, terms such as “first” and “second” are used only for the purpose of description and cannot be understood as indicating or implying relative importance or implicitly indicating the number of technical features denoted. Thus, features defined with “first” and “second” may explicitly or implicitly include one or more of the features. In the description of the present disclosure, unless otherwise specifically defined, “a plurality of” means two or more.

In the description of the present disclosure, it should be noted that, unless otherwise clearly specified and defined, meanings of terms “install”, “connect with”, and “connect to” should be understood in a board sense. For example, the connection may be a fixed connection, a detachable connection, or an integral connection; may be a mechanical connection or an electrical connection; may be a direct connection or an indirect connection with use of an intermediate medium; or may be intercommunication between two components. A person of ordinary skill in the art may understand specific meanings of the above terms in the present disclosure based on a specific situation.

The present disclosure will be described in detail below with reference to the accompanying drawings and the embodiments.

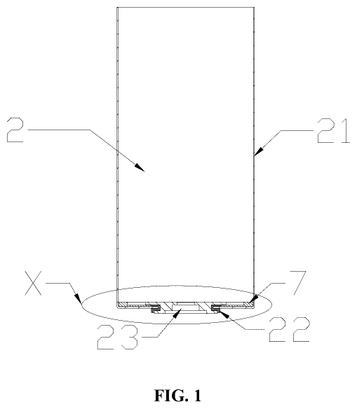

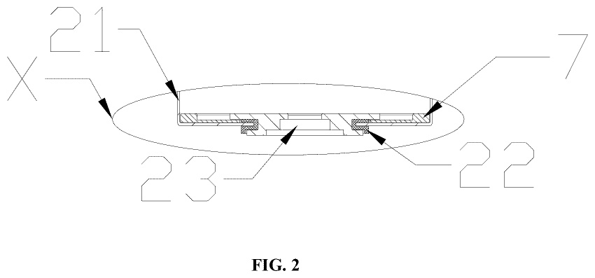

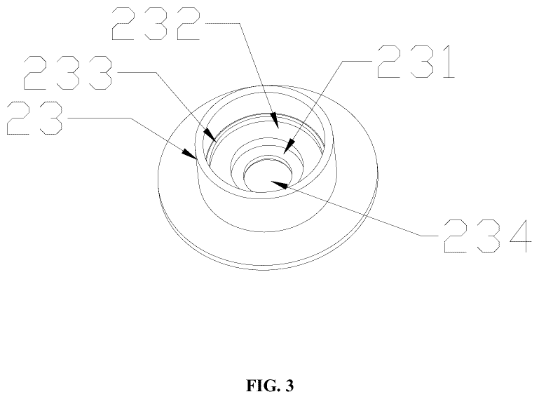

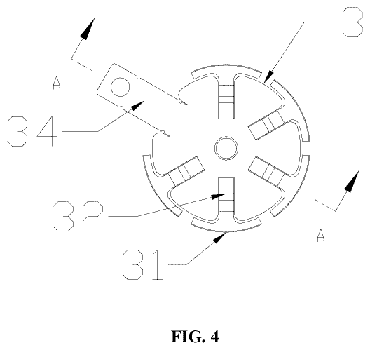

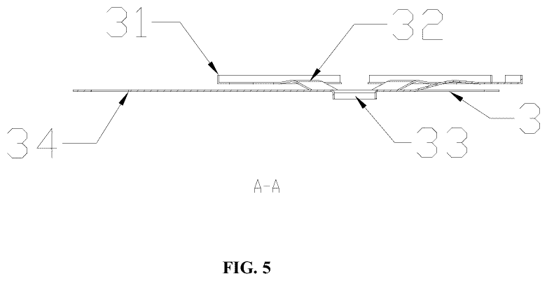

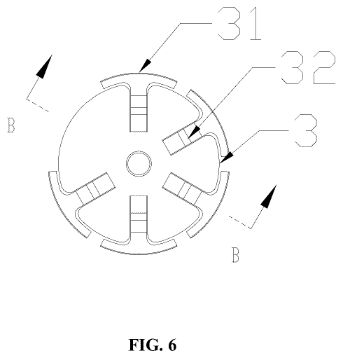

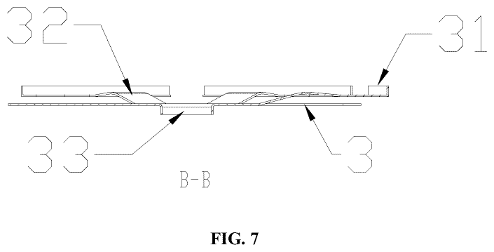

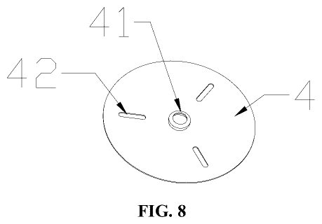

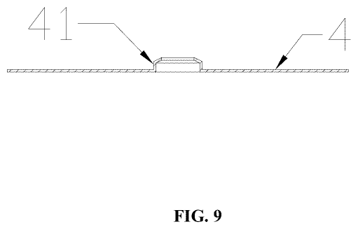

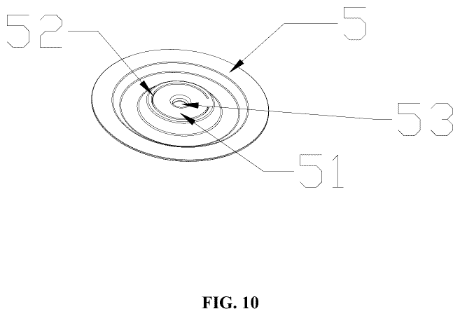

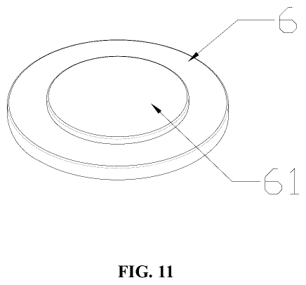

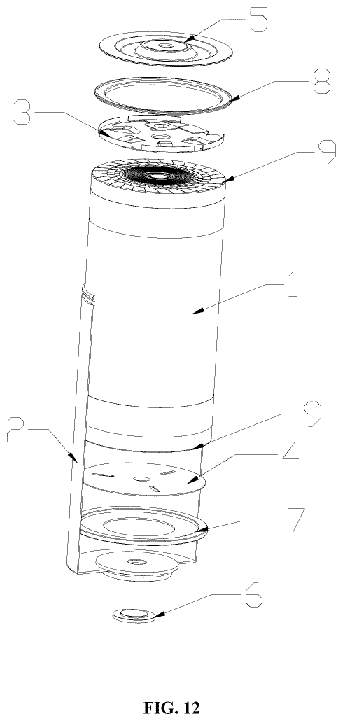

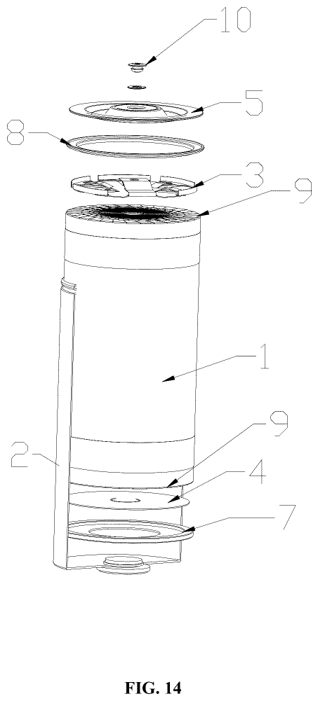

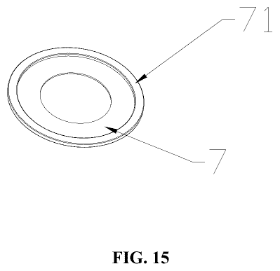

As shown in FIG. 1 to FIG. 15, a cylindrical battery includes a case assembly 2. A polar pillar 23 is fixedly connected under a case 21 of the case assembly 2. A second current collector 4, a jelly roll 1, a first current collector 3, and a cover plate 5 are provided sequentially in the case 21 from bottom to top. Tabs 9 at two ends of the jelly roll 1 are fixedly connected to the first current collector 3 and the second current collector 4, respectively. The second current collector 4 and the case 21 are insulated by an insulating element 7. A protrusion 71 is formed in a circumferential direction of the insulating element 7. A height of the protrusion 71 is identical to a height of the polar pillar 23. The cover plate 5 is fixedly provided on the first current collector 3. The cover plate 5 and the case 21 are sealed by a sealing ring 8. When a liquid injection hole is formed in the cover plate 5, a top of the cover plate 5 is sealed by a rivet 10. When the liquid injection hole is formed in the polar pillar 23, a bottom of the polar pillar 23 is sealed by a cap 6.

The jelly roll 1 is one of a full-tab jelly roll, a cut-and-stacked-tab jelly roll or a multi-tab jelly roll.

The case assembly 2 includes the case 21, a sealing element 22, and the polar pillar 23. The case 21 is a hollow cylindrical structure with an opening at one end, and a mounting hole at the other end. The mounting hole is configured to penetrate through the polar pillar 23, and riveted with the polar pillar 23. The polar pillar 23 and the case 21 are sealed by the sealing element 22. The sealing element 22 is a sealing ring.

The insulating element 7 is provided at a bottom of the case 21. The insulating element 7 is configured to prevent electrical conduction between the second current collector 4 and the case 21. Preferably, the insulating element 7 is an annular insulating element. A protrusion 71 is formed in a circumferential direction of the insulating element. After the case assembly 2 is assembled, a height of the protrusion 71 in the insulating element 7 is identical to a height of the polar pillar 23, so as to support the jelly roll 1.

In an embodiment, a cross-section of the polar pillar 23 is a T-shaped structure. The polar pillar 23 includes a center portion provided with a central hole 234, and the central hole 234 functions as the liquid injection hole. An inner wall of the polar pillar 23 is provided with a plurality of steps having gradually increased inner diameters. In the embodiment, there are three steps on the inner wall of the polar pillar 23, including a first step 231, a second step 232, and a third step 233. The first step 231 is configured to weld the second current collector 4 and the polar pillar. The second step 232 is configured to prevent pollution of an electrolyte in liquid injection or precharging from affecting a welded position of a sealing pin. The third step 233 is a plane after the polar pillar is riveted, and is configured to seal and weld the sealing pin and the polar pillar. The polar pillar has a central through hole, which facilitates connection between the current collector and the polar pillar, and can prevent the electrolyte in the liquid injection and the precharging from overflowing to pollute the welded surface. Integrated with a plurality of functions, the polar pillar prevents the manufacturing process from generating a defect or increasing a cleaning step.

In another embodiment, a cross-section of the polar pillar 23 is an I-shaped structure. The polar pillar 23 is directly riveted with the case 21 through the mounting hole in a sealing manner.

The first current collector 3 includes a first current collector body, a flange 31, an elastic structure 32, a first boss 33, and a conductive handle 34. The first boss 33 is provided at a center of the first current collector body. The first boss 33 matches with a central hole of the jelly roll 1 for location. A through hole structure is provided in the first boss 33. A plurality of elastic structures 32 are provided in a circumferential direction of the first boss 33. An end of each elastic structure 32 is fixedly connected to one flange 31. The flange 31 is located at an edge of the first current collector body. A direction of the flange 31 is opposite to a direction of the first boss 33. The elastic structure is in close fit with a roll groove of the case 21 to form electrically and thermally conductive connection.

A plurality of pedals are formed on the first current collector body by punching. The plurality of pedals are welded with the tab of the jelly roll 1. Two adjacent pedals are separated by the elastic structure 32.

In an embodiment, the elastic structure 32 is an arch structure, with one end fixedly connected to the first current collector body, and the other end provided with the flange 31. The elastic structure 32 can press the jelly roll, thereby preventing the jelly roll from moving in use to affect the reliability and service life of the cell in use.

Preferably, the first current collector 3 is further provided with the conductive handle 34. The conductive handle 34 is fixedly connected to the first current collector body. The conductive handle 34 may be formed integrally, and may also be welded subsequently by laser welding, ultrasonic welding and the like. One end of the conductive handle 34 is provided with a conductive handle through hole. The conductive handle through hole is riveted with the cover plate 5. The conductive handle 34 is connected to the cover plate, such that the electrical conductivity and the thermal conductivity are improved.

In an embodiment, the first current collector 3 is an integrated structure.

A second boss 41 is provided at a center of the second current collector 4. Permeation holes 42 are formed in a circumferential direction of the second boss 41.

The second boss 41 is inserted into the central hole 234 of the polar pillar 23. The second boss 41 is cooperatively welded with the first step 231 in a through hole of the polar pillar 23. In order to better cooperate with the central hole 234 of the polar pillar 23, the second boss 41 may be necked for ease of mounting. The permeation holes 42 facilitate permeation of the electrolyte, and injection of the electrolyte.

The cover plate 5 has an uneven structure. A cover plate boss 51 is provided on the cover plate 5. The cover plate boss 51 is configured to press the elastic structure 32 of the first current collector 3 after assembled, such that the elastic structure 32 is pressed to the case 21, thereby forming electrically and thermally conductive functions, and pressing the cell to prevent movement. An inner side of the cover plate boss 51 is riveted with the conductive handle through hole of the conductive handle 34 of the first current collector 3 to form electrically and thermally conductive connection. This improves production efficiency compared with the welding manner.

In an embodiment, a blind hole is formed in the cover plate boss 51. In another embodiment, the liquid injection hole 53 is formed in the cover plate boss 51. Upon liquid injection, the liquid injection hole 53 is sealed by pull riveting.

An explosion-proof snick 52 is provided on the cover plate 5, and configured for explosion protection and degassing in a failure of the battery.

The sealing ring 8 is provided between the cover plate 5 and the case 21, and configured to seal the cover plate 5 and the case 21 after assembled.

The cap 6 is a cylindrical structure. A cap step 61 is provided at a center of the cap 6. For ease of location in welding, the cap step 61 is a tapered structure. Meanwhile, the cylindrical structure can withstand a larger air pressure, so as to prevent gas generated in the failure of the cell from pushing the cap 6 open before an explosion-proof valve is open, and prevent a safety risk due a fact that heat generated in the battery is not dissipated according to a preset channel.

An assembly process of the cylindrical battery includes the following steps:

In step S1, the tabs of the wound jelly roll 1 are shaped, such that the tabs on the jelly roll are closely attached in a planar state.

In step S2, one of the tabs of the jelly roll 1 is laser-welded with the second current collector 4 to form a jelly roll assembly.

In step S3, the jelly roll assembly is inserted into the case 21 from an opening of the case 21.

In step S4, the second current collector 4 is welded with the polar pillar 21 for fixing.

In step S5, at the opening of the case 21, and at a position above the jelly roll 1, the case 21 is squeezed toward an axis through a die, and rolled to form a roll groove.

In step S6, the first current collector 3 is mounted, and the first current collector 3 is laser-welded with another one of the tabs of the jelly roll 1.

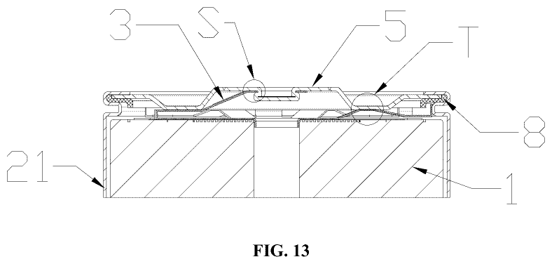

In step S7, the conductive handle 34 of the first current collector 3 is riveted with the cover plate 5 having the sealing ring 8. For a riveted position, see a portion S in FIG. 13.

In step S8, the cover plate 5 is pressed on the flange 31 of the first current collector at the opening of the case 21 toward the axis for sealing. Further, in order to realize stable electrical conductivity between the cover plate 5 and the case 21, the elastic structure 32 and the cover plate 5 may be welded to improve the electrical conductivity and the thermal conductivity. For a welded position, see a portion T in FIG. 13.

In step S9, liquid injection is performed through the liquid injection hole or the cell is dried and then the liquid injection is performed.

In step S10, formation, degassing, liquid replenishment and sealing are performed.

With a design in which the case is riveted with the polar pillar and the current collector is connected to the cover plate/the case, a positive electrode and a negative electrode are guided to a same side to facilitate design and welding of the current collector of the module or system. The flange of the case contacts the cover plate, thereby forming electrically and thermally conductive connection between the cover plate and the case. This facilitates heat dissipation of the whole cell.

In an embodiment, when the liquid injection hole is formed in the polar pillar 23, the assembly process of the cylindrical battery includes the following steps:

In step X1, the tabs of the wound jelly roll 1 are shaped, such that the tabs on the jelly roll are closely attached in the planar state.

In step X2, one of the tabs of the jelly roll 1 is laser-welded with the second current collector 4 to form the jelly roll assembly.

In step X3, the jelly roll assembly is inserted into the case 21 from the opening of the case 21.

In step X4, laser tailored welding is performed on the second current collector 4 and the polar pillar 21.

In step X5, at the opening of the case 21, and at the position above the jelly roll 1, the case 21 is squeezed toward the axis through the die, and rolled to form the roll groove.

In step X6, the first current collector 3 is mounted, and the first current collector 3 is laser-welded with another one of the tabs of the jelly roll 1.

In step X7, the conductive handle 34 of the first current collector 3 is riveted with the cover plate 5 having the sealing ring 8.

In step X8, the cover plate 5 is pressed on the flange 31 of the first current collector at the opening of the case 21 toward the axis for sealing. Further, in order to realize stable electrical conductivity between the cover plate 5 and the case 21, the elastic structure 32 and the cover plate 5 may be welded to improve the electrical conductivity and the thermal conductivity.

In step X9, the liquid injection is performed at the central hole 234 (namely the liquid injection hole) of the polar pillar 23 or the cell is dried and then the liquid injection is performed through the central hole 234 of the polar pillar.

In step X10, the formation, the degassing and the liquid replenishment are performed or the cap 6 is directly covered, and the polar pillar 23 and the cap 6 are laser-welded together for sealing.

In another embodiment, when the liquid injection hole is formed in the cover plate 5, the assembly process of the cylindrical battery includes the following steps:

In step Y1, the tabs of the wound jelly roll 1 are shaped, such that the tabs on the jelly roll are closely attached in the planar state.

In step Y2, one of the tabs of the jelly roll 1 is laser-welded with the second current collector 4 to form the jelly roll assembly.

In step Y3, the jelly roll assembly is inserted into the case 21 from the opening of the case 21.

In step Y4, the second current collector 4 and the polar pillar 21 are connected by laser welding or ultrasonic welding.

In step Y5, at the opening of the case 21, and at the position above the jelly roll 1, the case 21 is squeezed toward the axis through the die, and rolled to form the roll groove.

In step Y6, the first current collector 3 is mounted, and the first current collector 3 is laser-welded with the tab of the jelly roll 1.

In step Y7, the conductive handle 34 of the first current collector 3 is riveted with the cover plate 5 having the sealing ring 8.

In step Y8, the cover plate 5 is pressed on the flange 31 of the first current collector at the opening of the case 21 toward the axis for sealing. Further, in order to realize stable electrical conductivity between the cover plate 5 and the case 21, the elastic structure 32 and the cover plate 5 may be welded to improve the electrical conductivity and the thermal conductivity.

In step Y9, the liquid injection is performed at the liquid injection hole of the cover plate 5 or the cell is dried and then the liquid injection is performed through the liquid injection hole of the cover plate 5.

In step Y10, the formation, the degassing and the liquid replenishment are performed and the liquid injection hole is directly sealed by pull riveting.

Since there is no structure sealed by welding in the process, helium leak detection can be omitted in the manufacturing process, thereby lowering the cost and improving the manufacturing efficiency.

The above are merely preferred examples of the present disclosure, and are not intended to limit the present disclosure. Any modification, equivalent substitution, and improvement made without departing from the spirit and principle of the present disclosure should be included within the protection scope of the present disclosure.

What is claimed is:

1. A cylindrical battery, comprising a case assembly, wherein a polar pillar is provided under a case of the case assembly; a second current collector, a jelly roll, a first current collector, and a cover plate are provided sequentially in the case from bottom to top; tabs at two ends of the jelly roll are fixedly connected to the first current collector and the second current collector, respectively; the second current collector and the case are insulated by an insulating element; a protrusion is formed in a circumferential direction of the insulating element; a height of the protrusion is identical to a height of the polar pillar; the cover plate is fixedly provided on the first current collector; the cover plate and the case are sealed by a sealing ring; when a liquid injection hole is formed in the cover plate, a top of the cover plate is sealed by a rivet; and when the liquid injection hole is formed in the polar pillar, a bottom of the polar pillar is sealed by a cap.

2. The cylindrical battery according to claim 1, wherein a cross-section of the polar pillar is a T-shaped structure; and the polar pillar comprises a center portion provided with a central hole, and an inner wall of the central hole is provided with a plurality of steps having gradually increased inner diameters.

3. The cylindrical battery according to claim 1, wherein a cross-section of the polar pillar is an I-shaped structure; and the polar pillar is directly riveted with the case in a sealing manner.

4. The cylindrical battery according to claim 1, wherein the cover plate has an uneven structure; a cover plate boss is provided on the cover plate; the cover plate boss is configured to press an elastic structure of the first current collector after assembled; and an inner side of the cover plate boss is connected to a conductive handle of the first current collector.

5. The cylindrical battery according to claim 4, wherein a blind hole is formed in the cover plate boss.

6. The cylindrical battery according to claim 4, wherein the liquid injection hole is formed in the cover plate boss.

7. An assembly process of the cylindrical battery according to claim 1, comprising the following steps:
S1, shaping the tabs of the wound jelly roll, such that the tabs on the jelly roll are closely attached in a planar state;
S2, laser-welding one of the tabs of the jelly roll with the second current collector to form a jelly roll assembly;
S3, inserting the jelly roll assembly into the case from an opening of the case;
S4, welding the second current collector with the polar pillar for fixing;
S5, at the opening of the case, and at a position above the jelly roll, squeezing the case toward an axis through a die, followed by rolling to form a roll groove;
S6, mounting the first current collector, and laser-welding the first current collector with another one of the tabs of the jelly roll;
S7, riveting the conductive handle of the first current collector with the cover plate having the sealing ring;
S8, pressing the cover plate on a flange of the first current collector at the opening of the case toward the axis for sealing;
S9, performing liquid injection through the liquid injection hole or drying a cell and then performing the liquid injection; and
S10, performing formation, degassing, liquid replenishment and sealing.

8. The assembly process of the cylindrical battery according to claim 7, wherein when the liquid injection hole is formed in the polar pillar, the assembly process of the cylindrical battery comprises the following steps:
X1, shaping the tabs of the wound jelly roll, such that the tabs on the jelly roll are closely attached in the planar state;
X2, laser-welding one of the tabs of the jelly roll with the second current collector to form the jelly roll assembly;
X3, inserting the jelly roll assembly into the case from the opening of the case;
X4, performing laser tailored welding on the second current collector and the polar pillar;
X5, at the opening of the case, and at the position above the jelly roll, squeezing the case toward the axis through the die, followed by rolling to form the roll groove;
X6, mounting the first current collector, and laser-welding the first current collector with another one of the tabs of the jelly roll;
X7, riveting the conductive handle of the first current collector with the cover plate having the sealing ring;
X8, pressing the cover plate with the flange of the opening of the case toward the axis for sealing;
X9, performing the liquid injection at the central hole of the polar pillar or drying the cell and then performing the liquid injection through the central hole of the polar pillar; and
X10, performing the formation, the degassing and the liquid replenishment or directly covering the cap, and laser-welding the polar pillar and the cap together for sealing.

9. The assembly process of the cylindrical battery according to claim 7, wherein when the liquid injection hole is formed in the cover plate, the assembly process of the cylindrical battery comprises the following specific steps:
Y1, shaping the tabs of the wound jelly roll, such that the tabs on the jelly roll are closely attached in the planar state;
Y2, laser-welding one of the tabs of the jelly roll with the second current collector to form the jelly roll assembly;
Y3, inserting the jelly roll assembly into the case from the opening of the case;
Y4, connecting the second current collector and the polar pillar by laser welding or ultrasonic welding;
Y5, at the opening of the case, and at the position above the jelly roll, squeezing the case toward the axis through the die, followed by rolling to form the roll groove;
Y6, mounting the first current collector, and laser-welding the first current collector with another one of the tabs of the jelly roll;
Y7, riveting the conductive handle of the first current collector with the cover plate having the sealing ring;
Y8, pressing the cover plate with the flange of the opening of the case toward the axis for sealing;
Y9, performing the liquid injection at the liquid injection hole of the cover plate or drying the cell and then performing the liquid injection through the liquid injection hole of the cover plate; and
Y10, performing the formation, the degassing and the liquid replenishment or directly sealing the liquid injection hole by pull riveting.
